(19) United States
(12) Patent Application Publication
(10) Pub. No.: US 2015/0090784 A1
(43) Pub. Date: Apr. 2, 2015

(54) EMERGENCY CONTACT DEVICE

(71) Applicant: Helen Petaia, Springwood (AU)

(72) Inventor: Helen Petaia, Springwood (AU)

(73) Assignee: VITAL ONE TECHNOLOGIES PTY LTD, Springwood, Queensland (AU)

(21) Appl. No.: 14/238,388

(22) PCT Filed: Aug. 13, 2012
(86) PCT No.: PCT/AU2012/000954

§ 371 Date: Oct. 27, 2014

(30) Foreign Application Priority Data
Aug. 11, 2011 (AU) 2011903211

(51) Int. Cl. G06Q 50/24

(52) U.S. Cl. CPC G06Q 50/24
USPC 235/380; 235/494

(57) ABSTRACT

The present invention provides a device for accessing personal information including the personal and/or medical record of one or more individuals in the event of an emergency. An identification (ID) device of the individual and a code wherein the code is a Quick Response code specific to each individual to enable the retrieval of information. The code may either be applied to the device or embedded in the device. Alternatively, the code may be applied to a label which may be affixed to one or more devices.

### FIELD OF THE INVENTION

The present invention relates to a device and method to provide personal and/or medical details of an individual in the case of an emergency.

### BACKGROUND OF THE INVENTION

During an emergency situation such as injury to a person resulting from an accident or a medical emergency as a result of a medical condition, it is prudent to ensure that vital medical details of the person are available at the scene. It is well understood that the information available at the scene to stage 1 or first response personnel attending to the emergency or subsequently to stage 2 or qualified medical personnel such as ambulance officers or paramedics as soon as they arrive or remotely in order to speed up the ability to provide appropriate diagnosis and treatment is likely to be critical and, in certain circumstances, may determine whether or not the patient survives. This also potentially minimizes unnecessary pain and suffering.

Typically, medical records are kept in hardcopy such as paper or electronic form and kept in secure locations. Due to privacy considerations, access to this sort of information is restricted.

People generally engage in everyday activities remote from where their medical information is stored. Students may be anywhere within or outside the school grounds. Workers may be located at one or more workplaces or outside the workplace. In sporting activities, it is common for coaches or trainers who are responsible for sports training to file and store away medical records of those involved at a location remote from the game. In particular, travelers will typically be far from home and also from their locally stored medical records and may also be travelling in a remote location in the event of an accident or medical emergency.

Further, as individuals may consult numerous medical practitioners over a lifetime, the medical records and history of an individual may be stored in multiple disparate locations. This limits access to relevant and potentially lifesaving medical information in the case of an emergency. Access to the medical records and patient history takes time which may be critical at the scene of an accident or other life threatening situation. In addition, even where the medical record and/or history of an individual is accessible, for example, following admission to hospital, these records may be limited or incomplete.

Medical alert ID wristbands and jewellery are used to some extent by individuals with particular life threatening conditions such as allergy to penicillin. However, typically these tend to be utilized by only a small proportion of the population with such life threatening conditions and the storage of information on these devices is extremely limited.

Recent developments include storing of medical data on devices such as floppy disc or even on a compact disc (CD). However, these devices are truly not portable.

Further, these devices require a computer or a CD player to retrieve any information which is stored therein. The use of these devices is limited and it is relatively unlikely that they will be available for use at the scene of a medical emergency.

It is an object of the present invention to provide a convenient and efficient device and method to access personal and/or medical details of one or more individuals in the case of an emergency.

### SUMMARY OF THE INVENTION

The present invention provides a device for accessing personal information including the personal and/or medical record of one or more individuals in the event of an emergency comprising:

An identification (ID) device of the individual; and a code wherein the code is a Quick Response code specific to each individual to enable the retrieval of information.

Preferably, the code may either be applied to the device or embedded in the device. Alternatively, the code may be applied to a label which may be affixed to one or more devices.

Preferably, the code is scanned via a mobile telephone application to instantly retrieve personal details such as an electronic emergency summary or medical information of the individual.

Preferably the personal details are stored remotely on a server.

Preferably, the additional data or information of an individual may be accessed or retrieved by entering a unique login identity.

In another aspect of the invention, the invention provides an article for accessing the personal and/or medical record of one or more individuals in the event of an emergency comprising:

a device for storing data; and a code wherein the code is a Quick Response code specific to each individual to enable the retrieval of information.

Preferably, the device is selected from the group consisting of an identification card, a shoe tag, a wrist band, jewellery and/or additional material that may warrant or be appropriate for the inclusion of personal identification.

In another aspect of the invention, the invention provides a method of accessing the personal and/or medical record of an individual in the event of an emergency using a device or an article according to the present invention as described herein.

Throughout this specification and claims, unless the context requires otherwise, the word “comprise” or variations such as “comprises” or “comprising” will be understood to imply the inclusion of a stated integer or group of integers but not the exclusion of any other integer or group of integers.

### DETAILED DESCRIPTION OF THE PREFERRED EMBODIMENT

The present invention relates to a device and method to provide personal details of an individual in the event of an emergency.

The present invention, in particular, relates to a method and device for accessing information, including data such as the medical record and/or medical history of an individual which may be stored remotely, and accessed by another party such as first response personnel, medical personnel, carers and the like.

The present invention comprises a device with a unique Quick Response (QR) code, linked to an emergency contact site specific to that individual. Preferably, this emergency contact site is in the form of a unique URL where the information is stored.

The unique URL is generated on submission of an individual profile. The profile may be submitted by means of either a web based application or mobile telephone application. Preferably, the individual profile is able to be updated by the user so that the information is always up to date. Furthermore, any live updates from a mobile or web based application are immediately effective.

The QR code may be either applied to the device or embedded therein. Alternatively, the QR code may be applied to a label which may be affixed to one or more devices. This enables existing devices to be easily retrofitted.

The QR code is able to be scanned via a reading or detecting means and via the link to the URL is able to deliver information relating to that individual via wireless means so that the information is available within seconds. Preferably, this information comprises an electronic emergency summary containing vital personal and/or medical information which may be used in case of an emergency (ICE) situation. This information may optionally include a range of medical details including blood group, allergies, relevant medical history, details of current prescription drugs, and organ donor status together with other additional information such as medical insurance details, emergency contacts or next of kin.

The emergency summary may be available in a number of forms. For example, the emergency summary may optionally be placed on a customised emergency ID card. Alternatively, the emergency summary may be used in other print and/or digital information portals.

The information may be stored on one or more remote servers. For example, the information may be available by way of a cloud application.

The invention enables the provision of vital information relating to the individual to first response personnel attending to the emergency and/or to ambulance/paramedic personnel either as soon as they arrive or remotely thereby providing critical assistance in enabling early diagnosis and treatment.

Preferably, the QR code is able to be scanned by a mobile telephone application as these are portable, able to be used in most situations and are virtually ubiquitous. However, in certain locations other scanning devices may be more appropriate. For example, in remote locations it may be necessary to scan the QR code by other means such as a QR code reader on a satellite telephone. In surgery or hospital situations, a web based application may be preferred. Accordingly, this information may also be accessed by other mobile or web based applications and useful to doctors and medical staff in subsequent care and treatment.

The device stores information regarding the identity of the person (which may be important in situations where the person is unable to provide this information due to age or their condition) which may include photographic identification to assist in verification of identity.

Optionally, certain critical medical information such as blood type or information relating to a life threatening allergy to specific medicines may also be stored on the device itself which may also be read or scanned by first response or emergency personnel.

According to the present invention, the QR code has been developed to enable an emergency scan (Emergency Scan) which is specific to the individual. The Emergency Scan is linked to a unique URL that is converted to a QR code saved to a data capture device or system.

In order for a person to view the QR Emergency Scan, it is necessary to either install a QR reader or utilize a pre-installed QR reader. Preferably, this can be installed on the user's mobile telephone, particularly as this is portable and likely to be carried on their person in most situations. However, as a default the URL can also be typed into any browser.

The information may be stored on one or more remote servers. For example, the information may be available by way of a cloud application.

Once the code has been activated and viewed, it automatically links to another website to enable login to access an additional data storage facility or system which can optionally be used to provide further information relating to the individual. As the login is password protected, this may for example be used for confidential medical information or for a more detailed personal and/or medical record of the individual, if required. In addition to medical information this could optionally be used to store additional information. For example, this enables travelers to store passport information and copies of important travel documents.

Further and in addition to the above, a feature of the present invention is that it is possible for an individual profile to be linked with others in a specific group. One or more individual codes may be linked to a group account for a specific group. For example, if desired, individuals can be grouped by family, sporting club, school groups, workplace group or location. This is particularly useful for families, sporting clubs, schools and employers as this enables the generation of an emergency summary for that group.

Videos, ebooks and PDF files may also be accessed via the QR scan and may add extra benefits to the card by way of emergency information. In relation to individual or group accounts, these could, for example, be linked to emergency instructions, maps, or material safety data sheet (MSDS) information in the case of a chemical emergency. Updates to this information are then available to the entire group.

In one embodiment, the device of the present invention comprises an identity card which enables access to stored data. The card stores information regarding the identity of the person and has a unique QR code which may be either applied to the card or embedded therein. Additional information may also optionally be stored on the card itself. For example, the card may also optionally contain photographic identification. As a further option, the card may contain a copy of the emergency summary in either full or abridged form. Optionally, the card may display certain information contained in the emergency summary.

Preferably, the ID card is comprised of material which is weather proof, for example waterproof material. Multiple copies of the card may optionally be provided to other nominated or selected family members and/or authorised personnel to allow access to any critical information which may be required in the event of an emergency situation concerning the individual.

The device of the present invention has numerous applications in sport, travel, workplaces for occupational health and safety purposes, schools (particularly for sports, excursions and external activities). During sporting and recreational events and related activities or other areas such as travel, in workplaces, schools, and the like, the ID card or other device may be carried on the person or by the appropriate responsible person or supervisor during the relevant activity and kept within a convenient distance so that the information is easily and readily accessible, if required. Depending upon the context, the responsible person or supervisor may be a teacher, administrative officer in charge, coach or trainer.

In the event of an injury, the card or other device may then be quickly retrieved to display urgent identification data and/or medical allergies which may be sighted or scanned immediately to access the relevant information. Any first aid or medical personnel at hand could then attend to the injured individual effectively and efficiently based on the vital information contained in the emergency summary and/or other medical records. The above example provides the emergency personnel direct access to patient data at the most critical time.

In one embodiment of the invention, the programs according to the present invention create a user interface to store emergency information and personal health records of an individual and which enables the production of a portable storage device. Such devices may be in the form of an ID card, a shoe tag, a wrist band, jewellery and/or additional material that may warrant or be appropriate for the inclusion of personal identification.

In another embodiment of the invention, data may be collected by way of a cloud application that can be accessed on any web enabled device such as a computer, tablet, mobile telephone etc. The initial data collected on a “mini application” is the data required to populate the information for the front face of the device and is also used to generate the customized emergency action plan that is specific to that individual. The emergency scan is then linked to a unique URL that is converted to a QR code specific to that individual and included in the images which are used to populate the device.

After this process has been completed, a user name and password is automatically created that links to the specific user and enables the user via secure login to edit the emergency action plan as necessary. This process enables the information specific to that individual to be constantly updated in real time.

In addition, once the mini application is completed, the user then is also given the option to access additional storage of Vital Information on a “Main Application” which enables access to further data and document storage such as medical records which may be unrelated to the emergency summary or contain ancillary information. This information is only available via individual login.

In addition, by entering the emergency scan feature, it is possible to optionally add links that can work seamlessly to link and/or integrate with additional records of that individual such as a PCEHR (Personally Controlled Ehealth Record). It is up to the user to decide whether or not to activate such links. The individual and those with approved authority are able to control this access externally to secure applications.

The underlying fundamental principle of all these application is Vital Information in Seconds—being able to provide Quick, Accurate, Reliable (real time updating) and Universal Access (on the assumption of scanning or web connectivity).

In another further embodiment, the present invention provides access to emergency scan software, such as software that drives the creation of the emergency scan for inclusion on the ID card or other suitable device which can also interface with existing software. This software includes ID card software by way of API (application program interface) to broaden the opportunity to include the emergency scan within existing product offerings from other providers.

The present invention has wide application including, for example, use of the QR code to provide access to medical and other information in areas particularly including, but by no means limited to, sports, travel, in workplaces for occupational health and safety (OH&S) purposes, and in schools. Furthermore, in addition to use of the emergency scan image in ID cards, the present invention provides for the ability to utilize the emergency scan image in other devices. Examples of such other devices include and are not limited to a shoe tag that can be threaded into the shoe laces (particularly useful in sporting activities), wristbands, jewellery and/or additional material that may warrant or be appropriate for the inclusion of personal identification. All of these devices including the Emergency Scan image may also optionally include a photograph to ensure positive ID of the individual thereby providing a useful cross-check to ensure that the emergency information displayed is accurate.

The advantages of the present invention include rapid access to emergency information and ensuring that the data is accurate and up to date while also addressing personal privacy considerations. The combination of the product and service provides efficient and timely access within seconds to vital information in the event of an emergency which can be used to assist in rapid diagnosis and treatment at the scene. This ensures that first response and emergency personnel are empowered with critical information, thereby saving valuable time in the treatment of an individual in an emergency situation. In certain circumstances, this may mean the difference between life and death.

While considerable emphasis has been placed herein on the specific features of the preferred embodiments described herein, it will be appreciated that the foregoing description has been given by way of illustrative example of this invention and is to be interpreted merely as illustrative of the invention and not as a limitation, and that many additional features can be added and that many changes can be made in the preferred embodiment without departing from the principles of the invention. All such and other modifications and variations thereto as would be apparent to persons skilled in the art from the disclosure herein are deemed to fall within the broad scope and ambit of this invention as is herein set forth.

1. A device for accessing personal information including the personal and/or medical record of one or more individuals in the event of an emergency comprising:
An identification device for each individual; and a code wherein the code is a Quick response code specific to each individual to enable the retrieval of information.

2. A device according to claim 1 wherein the device is one selected from the group comprising an identification card, a shoe tag, a wrist band, jewellery and/or additional material that may warrant or be appropriate for the inclusion of personal identification.

3. The device according to claim 1 wherein the code is applied to the device.

4. The device according to claim 1 wherein the code is applied to a label which may be affixed to one or more devices.

5. The device according to claim 1 wherein the code is embedded in the device.

6. The device according to claim claim 1 wherein the code is scanned via a mobile telephone application to instantly retrieve personal details such as an electronic emergency summary or medical information of the individual.

7. The device according to claim 8 wherein the personal details are stored remotely on one or more servers.

8. The device according to claim 1 wherein additional data or information of an individual may be accessed or retrieved by entering a unique login identity.

9. The device according to claim 1 wherein the one or more individual codes may be linked to a group account for a specific group.

10. An article for accessing the personal and/or medical record of one or more individuals in the event of an emergency comprising:
A device for storing data; and a code wherein the code is a Quick response code specific to each individual to enable the retrieval of information.

11. The article according to claim 10 wherein the device is selected from the group comprising an identification card, a shoe tag, a wrist band, jewellery and/or additional material that may warrant or be appropriate for the inclusion of personal identification.

12. The article according to claim 10 wherein the code is scanned via a mobile telephone application to instantly retrieve personal details such as an electronic emergency summary or medical information of the individual.

13. The device according to claim 12 wherein the personal details are stored remotely on one or more servers.

14. The device according to claim 10 wherein additional data or information of an individual may be accessed or retrieved by entering a unique login identity.

15. The device according to claim 10 wherein the one or more individual codes may be linked to a group account for a specific group

16. A method of accessing the personal and/or medical record of one or more individuals in the event of an emergency using a device or an article according to claim 1.

17. A method of accessing the personal and/or medical record of an individual in the event of an emergency according to claim 16 wherein one or more individual codes may be linked to a group account for a specific group.

18. (canceled)
